(19) United States
(12) Patent Application Publication
(10) Pub. No.: US 2025/0162256 A1
(43) Pub. Date: May 22, 2025

(54) BUILD MATERIAL POWDER PROCESSING UNIT

(71) Applicant: Desktop Metal, Inc., Burlington, MA (US)

(72) Inventors: Peter ZUMMO, Burlington, MA (US); Martin BUJWID, Burlington, MA (US); George HUDELSON, Burlington, MA (US)

(21) Appl. No.: 18/840,113

(22) PCT Filed: Feb. 15, 2023
(86) PCT No.: PCT/US2023/013083

§ 371 Date: Aug. 21, 2024

Related U.S. Application Data
(60) Provisional application No. 63/312,286, filed on Feb. 21, 2022.

(51) Int. Cl. B29C 64/314; B29C 64/321; B29C 64/357; B33Y 30/00; B33Y 40/10

(52) U.S. Cl. CPC B29C 64/314; B29C 64/321; B29C 64/357; B33Y 30/00; B33Y 40/10

(57) ABSTRACT

A method of processing build material powder for binder jetting additive manufacturing. Build material powder requiring sieving is received in a first container at a sieving station where it is passed through a first conveyance loop to a sieving unit. After sieving the build material powder is deposited in a second container. The second container of build material powder, now sieved, is taken to a feed conveyance station. The feed conveyance station passes the build material powder from the second container to a binder jetting printer via a second conveyance loop.

### RELATED APPLICATIONS

This application is a US National Stage Application, filed under 35 U.S.C. § 371, of International Application PCT/US2023/013083, filed on Feb. 15, 2023 and claims priority to U.S. Patent Application 63/312,286, filed on Feb. 21, 2022; the above applications are incorporated by reference herein in their entirety.

### TECHNICAL FIELD

Various aspects of the present disclosure relate to a curing build material powder used in binder jetting additive manufacturing.

### BACKGROUND

Binder jetting is an additive manufacturing technique by which a thin layer of powder (e.g. 65 μm) is spread onto a bed, followed by deposition of a liquid binder in a 2D pattern or image that represents a single “slice” of a 3D shape. After deposition of binder, another layer of powder is spread, and the process is repeated to form a 3D volume of bound material within the powder bed. After printing, the bound part may be, in reversible order, cured or crosslinked to strengthen the binder, and removed from the excess build material powder.

Build material powder used in binder jetting presents numerous challenges. Build material powder that is new or that has been used in a printing process several times may require curing prior to use. Further, certain materials in powder form represent an explosion and/or health hazard. At times prior to use build material powder also requires sieving to remove clumps. It is also highly desirable to recover excess build material powder from both printing and de-powdering operations for reuse. It is thus desirable for a system for powder processing that minimizes the need to manually transfer build material powder between different containers while allowing for expedient curing.

### SUMMARY

Disclosed is a powder processing unit (PPU) configured to provide a full range of powder processing functions necessary to supply build material powder to binder jetting printers. A curing station is configured to cure new build material powder and build material powder that has been used in a binder jet printing process. A sieve station is configured to sieve build material powder in preparation for printing. A feed conveyance station supplies build material from containers to a binder jetting printer. Excess build material powder from the binder jetting printer accumulated during printing operations is collected by an overflow station for later recycling. Lastly, a de-powder station collects build material powder de-coupled from printed parts during de-powdering, again for later recycling. Each of the components of the PPU is configured to operate with a single container type, providing an efficient solution compared to legacy processing methodologies.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments. There are many aspects and embodiments described herein. Those of ordinary skill in the art will readily recognize that the features of a particular aspect or embodiment may be used in conjunction with the features of any or all of the other aspects or embodiments described in this disclosure.

FIG. 1 depicts a component schematic diagram of a binder jetting printer for use with embodiments of the present disclosure.

FIG. 2 depicts a cutaway view of the binder jetting printer of FIG. 1.

FIG. 3 depicts a schematic view of an embodiment powder processing unit.

FIG. 4 depicts a schematic view of an embodiment feed conveyance station.

FIG. 5 is a perspective view of an embodiment feed conveyance station.

FIGS. 6A-D depict a three drum support structure for use in embodiment parts of the powder processing unit of FIG. 3.

FIG. 7 depicts a schematic view of an embodiment sieve station.

FIG. 8 is a perspective view of an embodiment sieve station.

FIG. 9 is a schematic view of an embodiment overflow conveyance station.

FIG. 10 is a perspective view of an embodiment overflow conveyance station.

FIG. 11 is a schematic view of an embodiment de-powder conveyance station.

FIG. 12 is a perspective view of an embodiment de-powder conveyance station.

### DETAILED DESCRIPTION

In the process of binder jetting additive manufacturing, a build material powder is delivered to and spread upon a build surface and a binding agent (or binder or ink) is deposited on the build material powder to at least partially bind the build material powder to form a slice of a 3D object. By repeating the steps of delivering a build material powder, spreading a build material powder, and depositing a binder corresponding to a desired image, a 3D structure may be formed. This process is understood to occur in a binder jetting printer (or binder jet printer).

In certain embodiments, a binder jet printer may comprise a print enclosure with a number of modules configured to aid in or accomplish the additive manufacturing of parts and other objects from a build material powder. These modules may include: (1) an assemblage of printheads (or one printhead in certain embodiments), (2) an ink delivery system to supply the printheads with binder at flow and pressure conditions necessary for stable binder ejection from the printhead, (3) a build material supply module to deliver an amount of build material powder to a print surface (also referred to as a work plane) within the printer, (4) a build material spreading module to spread an amount of build material powder which has been supplied to a print surface to a controlled thickness, (5) a container and motion system to contain the build material powder (commonly referred to as a build box) and during printing move the container to specific positions (e.g., by moving in a first direction relative to a least one of the modules (1)-(4)) to enable the fabrication of successive layers of an object. In some embodiments, the printer may comprise additional modules including: (6) devices configured to reduce, prevent, or remove build material powder and/or ejecta from the printhead that may become suspended in an atmosphere in the print enclosure, including, according to certain embodiments, devices which deposit liquids (e.g., water, alcohol, oils, and the like) onto a surface of the build material powder to alter the cohesive characteristics of the powder, devices which control and/or provide a flow of gas to remove and/or filter suspended ejecta, (7) devices configured to control the gaseous atmosphere within the print enclosure relative to a gaseous atmosphere surrounding the binder jet printer, and (8) at least one reciprocating mechanism to provide relative motion between the container containing build material powder and at least one of the modules (1) to (4) in a second direction different from the first direction of the container and indexing system. In some embodiments, a cart may be used to transport, move, or store the build box from the printer to subsequent processing operations, including a crosslinking (or heating or curing step), a depowdering step, or a storage location. The cart may be designed to raise and lower the build box to interface with the printer or other processing equipment.

Build material powders may be sensitive to certain gaseous atmospheres. According to certain embodiments, it is desirable to prevent, minimize, or otherwise avoid gaseous communication between certain gaseous species and specific metal powders. For example, a copper build material powder may oxidize when in contact with air. In certain embodiments of the binder jetting printing process, such an oxidation of copper may be deleterious to the printing process for at least the reason that the oxidation may be uncontrolled and may introduce uncertainty into certain aspects of the binder jet printing process. In certain embodiments, a build material powder may be reactive (e.g, pyrophoric or explosible) with moisture and the build material powder should be kept separate from a base level of moisture contained in ambient air (e.g., room humidity). In certain embodiments, a build material powder may not be chemically sensitive (e.g., prone to oxidation, explosibility, pyrophoricity, or other means of chemical reaction) but may exhibit a change in physical properties such as the ability of the build material powder to flow. In the case where the flow characteristics of the powder will vary, degrade, or otherwise change, maintaining a consistent atmosphere around the build material powder may be required.

In another embodiment, build material powders may be reactive (e.g. pyrophoric or explosible) in the presence of oxygen and ignition sources capable of providing energy above the minimum ignition energy or temperatures above the minimum ignition temperature of the powder. Certain of the process modules (1) to (8) may provide sufficient energy or temperature to exceed these ignition limits, creating a condition in which a reaction may occur. In such cases, it may be desirable to maintain the printing environment in an inerted state, with the oxygen concentration of the atmosphere maintained below a predetermined concentration which is lower than the limiting oxygen concentration, or the concentration below which combustion of the build material powder does not readily occur. A typical target oxygen concentration may be 2%, which is below a typical limiting oxygen concentration of 4-15% for commonly printed materials.

Inerting, or maintaining an environment in an inert or an inerted state, may be different for different materials. Generally, a state of inertness depends upon the phenomena desired for suppression, the materials, and the associated objects and machinery involved. As inerting pertains to the additive manufacturing of finely divided, or otherwise powdered, build materials, it is often desired to avoid the possibility of certain deleterious and harmful chemical reactions between a gaseous atmosphere and the build material-such as explosions, exothermic reactions, gas-generating reactions, and the like. In certain embodiments, inerting can be accomplished by providing an atmosphere substantially free of oxygen. In certain embodiments, inerting can be accomplished by providing an atmosphere substantially free of water and/or water vapor. In certain embodiments, inerting requires the deliberate maintenance of specific atmospheric conditions (e.g., limits or windows on all or any combination of temperature, concentration thresholds of specific gas types, and humidity, for example), which may necessitate managing or preventing the egress of atmospheric gases into the process chamber of process equipment in which a build material powder is located.

In the process of binder jet additive manufacturing, a build material powder is typically supplied to a binder jet printer and some amount of this build material powder is bound using a binder to form objects. These objects are provided with various names in the field of art, and may be referred to as green parts, but are sometimes also referred to as brown parts. In certain embodiments, the objects formed may include parts that, as one skilled in the art will appreciate, may undergo subsequent post-processing steps (perhaps including a curing, drying, or crosslinking step) to improve the mechanical properties (such as strength, fracture toughness, elongation to failure, and the like) of the bound object.

### Post-Processing

In certain embodiments, post-processing (such as curing, drying, crosslinking, and the like) may be optionally performed to improve the mechanical properties of objects fabricated from build material powder and binder. In certain embodiments, the improvement of mechanical properties attained during the post-processing steps may reduce breakages of objects that can occur during the removal of unbound build material powder from the surfaces of the objects formed from binder and build material powder. This process of removing unbound build material powder (that is, powder which is not held or adhered to an object with binder) is often termed “depowdering”. As one skilled in the art may appreciate, several approaches may be pursued to depowder parts.

### Objects: Parts and Supports

Several types of objects may be printed using a binder jet printer. In certain embodiments, a single object may comprise a single part. In certain embodiments, a single object may comprise a series of parts connected with a mechanical linkage permitting relative motion (such as a hinge, slide, or other element). In certain embodiments, a single object may comprise a series of parts connected with a mechanical linkage in which motion is prohibited, substantially prohibited, or the parts are otherwise fully constrained in all directions of translation and rotation. In certain embodiments, a single object may comprise a series of parts connected with at least one mechanical linkage permitting motion in at least one direction, and prohibiting motion in at least one other direction (such as, for example, in a sliding mechanism permitting motion in a first sliding direction with constraint imposed in a second constraining direction orthogonal to the first direction). In certain embodiments, a single object may comprise a part and a supporting structure, where the supporting structure may be configured to touch, abut, hold, cradle, or otherwise contact the part at or through at least one point across opposed surfaces of the part and support structure. In certain embodiments, the support structure may provide a means of support to the part. In certain embodiments, the means of support may be mechanical, such that the support structure, through the at least one point, carries a stress or force transmitted through or imposed upon the part. In certain embodiments, the part and the support may be printed in a first configuration and brought to contact in a second configuration, where the second configuration enables the support structure to provide support to the part.

### Thermal Processing

Following binder jet printing and optional post-processing of the object, the object may be further subjected to thermal processing, according to certain embodiments. The thermal processing may include the steps of debinding and sintering of the object.

### Debinding

During debinding, binder is removed from the object. Debinding may be performed in any suitable chamber or enclosure. In certain embodiments, a suitable chamber or enclosure may include a means of heating the object, a means of providing a flow of process gas, a means of evacuating a process gas, and a means of controlling a pressure of the process gas, as will be appreciated by one skilled in the art.

Not being bound by theory, debinding may remove binder by a thermally activated process of evaporation, sublimation, combustion, oxidation, or degradation, according to certain embodiments. Depending upon the specific binder and build material powder materials in the object undergoing debinding, the debinding process may be tailored to achieve the desired amount of debinding.

In certain embodiments, the debinding process may begin at any temperature from the list of starting debinding temperatures: 200, 250, 300, 350, 400, or 450 degrees centigrade. In certain embodiments, the debinding process may end at any temperature from the list of ending debinding temperatures: 250, 300, 350, 400, 500, or 600 degrees centigrade. For example, a debind process may occur between 200 and 350 degrees centigrade, or may occur between 300 and 600 degrees centigrade. It should be understood by one skilled in the art that the starting debinding temperature will be less than the ending debinding temperature.

The debinding process may require the maintenance of a specific gaseous atmosphere surrounding the objects, according to certain embodiments. The gaseous atmosphere may include the gases argon, nitrogen, oxygen, hydrogen, helium, carbon dioxide, carbon monoxide, ammonia, methane, air, or the like. According to certain embodiments, the gaseous atmosphere may be a mixture of gases. According to certain embodiments, the gaseous atmosphere may be substantially absent and a vacuum may exist about the parts. According to certain embodiments, a gaseous atmosphere may be provided by a process gas.

The debinding process may require, or more optimally perform with a specific pressure or range of pressures of a process gas. According to certain embodiments, the pressure of the gaseous atmosphere during debinding may be equal to or may exceed 1 atmosphere. According to certain embodiments, the pressure of the gaseous atmosphere during debinding may be between 0.5 and 1 atmosphere. According to certain embodiments, the pressure of the gaseous atmosphere may be between 0.01 and 0.5 atmospheres. According to certain embodiments, the pressure of the gaseous atmosphere may be between 0.01 and 10 Torr. According to certain embodiments, the pressure of the gaseous atmosphere may be less than 0.01 Torr. In certain embodiments, a desired pressure may be maintained with a vacuum pump and a supply of process gas, where the volume of gas removed by the pump and the supply of process gas at least partially determine the pressure within the debind chamber.

### Sintering

Following the removal of at least a portion of the binder by the debinding process, the object may then be sintered, according to certain embodiments. In certain embodiments, the objects may be sintered without the removal of the binder, or without the binder removal step.

Not being bound by theory, during the process of sintering, the build material powder is heated to result in the joining of the build material powders to form a sintered object. The sintered object may exhibit a density larger than the density of the object prior to sintering, according to some embodiments. The object may be sintered without the melting of any build material powder, according to certain embodiments. The object may be sintered with the melting of only a portion of the build material powder, according to certain embodiments.

The process of sintering typically occurs in a sintering furnace, as will be appreciated by one skilled in the art. According to some embodiments, the sintering furnace may include a means of heating the object to be sintered. According to some embodiments, the sintering furnace may include a means of providing a flow of sintering process gas to the objects to be sintered, in such a way that the gaseous atmosphere around the objects to be sintered is at least partially controlled. According to some embodiments, the sintering furnace may include a means of controlling the pressure of a gaseous atmosphere around the objects during the sintering process (the “sintering pressure”). According to some embodiments, the means of controlling the pressure of a gaseous atmosphere around the objects during sintering may include a vacuum pump and at least one conduit to enable gaseous communication between a chamber housing the object to be sintered and the vacuum pump.

The gaseous atmosphere surrounding the object during sintering is often an important aspect of the sintering process. According to certain embodiments, the gaseous atmosphere may be comprised of hydrogen, helium, argon, nitrogen, carbon dioxide, carbon monoxide, methane, forming gas (a mixture of hydrogen and argon), ammonia, or air. According to certain embodiments, the gaseous atmosphere may be comprised of a mixture of gasses (95% nitrogen and 5% hydrogen by weight, for example). Careful selection of the gaseous atmosphere may promote certain mechanisms of sintering and lead to a desired amount of densification. As will be understood by one skilled in the art, the composition of the gaseous atmosphere surrounding the object during sintering may change during the sintering process, for example according to a predetermined schedule and in a coordinated fashion with the temperature, pressure, and flow rates as a function of time.

The pressure of the gaseous atmosphere surrounding the object during sintering is often an important aspect of the sintering process. According to certain embodiments, it is desirable to decrease the pressure in the sintering furnace to enhance the densification (that is, to increase the density) of an object undergoing sintering. According to certain embodiments, it is desirable to increase the pressure in the sintering furnace to enhance the densification (that is, to increase the density) of an object undergoing sintering. The selection of pressure is typically determined by the elements from which the build material powder is comprised in addition to the interaction of the elements with the gaseous atmosphere. In certain embodiments, the pressure of the gaseous atmosphere surrounding the object during sintering is at least 1 atmosphere and up to 5 atmospheres. In certain embodiments, the pressure of the gaseous atmosphere surrounding the object during sintering is at least 0.5 atmosphere and less than 1 atmosphere. In certain embodiments, the pressure of the gaseous atmosphere surrounding the object during sintering is at least 0.1 atmosphere and less than 0.5 atmosphere. In certain embodiments, the pressure of the gaseous atmosphere surrounding the object during sintering is at least 0.001 Torr atmosphere and less than 10 Torr. In certain embodiments, the pressure of the gaseous atmosphere surrounding the object during sintering is less than 0.001 Torr. As will be understood by one skilled in the art, the pressure of the gaseous atmosphere surrounding the object during sintering may change during the sintering process, for example according to a predetermined schedule and in a coordinated fashion with the temperature, composition, and flow rates as a function of time.

In some embodiments, the steps of debinding and sintering may occur during a sequentially in the same chamber, as part of a processing operation. For example, a single furnace may be used to first debind a part by controlling its temperature through starting and ending debind temperatures, and continuing to sintering temperatures without first cooling the part from the ending debind temperature.

### Build Material Powders

In certain embodiments, the build material may be any finely divided material or powder. The finely divided material may be a metal, oxide ceramic, non-oxide ceramic, glass, cermet, organic material, carbide, nitride, or any mixture, according to certain embodiments.

In certain embodiments, the build material may comprise a metallic powder. In certain embodiments, the metallic powder may comprise a pure element (such as elemental copper or iron). In certain embodiments, the metallic powder may comprise an alloy of metallic elements to form a specific grade of metal, such as 17-4 stainless steel, 316 stainless steel, 316L stainless steel, 4140 low alloy steel, Inconel 718, Inconel 625, 6061 aluminum, 7075 aluminum, Ti-6Al-4V titanium, F75 Co—Cr—Mo, or any other alloy capable of being produced in a powdered or finely-divided form. In certain embodiments, the metallic powder may comprise a mixture of powdered metallic elements purposed to achieve the desired chemical specification of an alloyed metal (for example, a mixture including elemental Co, Cr, and Mo powders to form an F75 alloy, or a mixture including Fe, Cr, V, C, Mn, Si, and Ni to form a stainless steel). In certain embodiments, the build material may comprise a metallic powder where the metal is a refractory metal (such as tungsten, tantalum, niobium, rhenium, molybdenum, hafnium, zirconium, or the like).

In certain embodiments, the build material may comprise a ceramic powder. In certain embodiments, the ceramic powder may comprise alumina, zirconia, yittria-stabilized zirconia, mullite, silica, chromia, spinel, and the like. In certain embodiments, the build material may be a mixture of ceramic powders (for example, silica and alumina, or magnesium oxide and alumina).

In certain embodiments, the build material may be naturally derived, as an organic material. In certain embodiments, the organic material may comprise a wood flour, sawdust, cellulosic fiber, or the like.

In certain embodiments, a curing process may be employed to vary the properties of a build material powder. In certain embodiments, the curing process may include such process features as (1) the application of heat to a build material powder, (2) the agitation of a build material powder, (3) the maintenance of a controlled atmosphere about the build material powder, (4) the flow and withdrawal of gases to an area (or volume) in which the build material powder is present, (5) the creation of a vacuum in a volume in which the build material powder is present, (6) the removal of heat (or cooling) of the build material powder, or other process features as described and disclosed herein.

In certain embodiments, the application of heat may be used to change a state of the build material powder. In certain embodiments, molecules, or any other matter may be stuck or adhered to the surface of the build material powder, and may affect the ability of the build material powder to flow, pact, compact, sinter, or interact with at least some aspect of the binder jet printing process. Changing a state of a build material powder may include changing the amount of moisture on the surface of the build material powder, in certain embodiments. For example, the build material powder may retain some amount of water vapor, bulk water, or any other type of moisture on the surface of the build material powder, In certain embodiments, the application of heat may result in, or at least assist in, the removal or decrease in (as compared to the build material powder prior to the application of heat) an amount of moisture present on the surface of the build material powder.

In certain embodiments, the surface of the build material powder may retain, be at least partially covered by, or otherwise be attached to organic molecules such as oils, waxes, alcohols, and the like. In certain embodiments, the application of heat may result in, or at least assist in, the removal or decrease in (as compared to the build material powder prior to the application of heat) an amount of organic molecules present on the surface of the build material powder.

In certain embodiments, the curing of build material powder may include the agitation of the build material powder. The agitation of the build powder may serve to mix the components of the build material powder. The agitation of the build material powder may be performed in concert with any other curing process feature such as heating, in certain embodiments. In certain embodiments including the agitation of the build material powder, and without being bound by theory, the agitation may physically affect the surface of the build material powder (perhaps by altering the surface roughness). In certain embodiments, the agitation of the build material powder may aid in the distribution of heat (when the powder, or any container in which the powder is contained, is heated or cooled). In certain embodiments, the agitation of the build material powder may aid in the removal of species (such as water, water vapor, oils, alcohols, other organics, and the like) from the surface of the build material powder by reasons

In certain embodiments, the curing of the build material powder may include the control of the gaseous atmosphere about the build material powder. In certain embodiments, the build material powder may be exposed to a specific gaseous atmosphere. The gas atmosphere may be chosen to modify the surface of the build material powder by, for example, oxidation, carburizing, or nitriding. The specific gas atmosphere utilized may depend upon the build material powder.

In certain embodiments, the gaseous atmosphere to oxidize a powder may include or primarily consist of an oxidizing gas such as oxygen, air, water vapor, carbon monoxide, or carbon dioxide. In certain embodiments, for the case of iron-contain metals and alloys including, but not limited to, carbonyl iron, iron, carbon steels, midcarbon steels, tool steels, stainless steels, and the like, an oxidizing gas may be provided, optionally with an amount of heat or agitaton to oxidize the build material powder and increase the amount of oxygen the powder. One skilled in the art will appreciate that a range of oxidizing gases and temperatures may be employed, and the range may dependent upon the composition of the alloy which is intended to be cured.

In certain embodiments, the gaseous atmosphere to nitride a powder may include or primarily consist of a nitriding gas such as ammonia or nitrogen. In certain embodiments, the gaseous atmosphere to carburize a powder may include or primarily consist of methane, acetylene, carbon monoxide, or carbon dioxide.

In certain embodiments, the curing of the build material powder may increase the oxygen content from between 10 and 1000 parts per million, In certain embodiments, the curing of the build material powder may increase the oxygen content from between 100 and 10,000 parts per million. In certain embodiments, the curing of the build material powder may increase the oxygen content from between 1,000 and 100,000 parts per million. In certain embodiments, the curing of the build material powder may negligibly affect the oxygen content of the build material powder, such that the oxygen content before and after curing is statistically insignificant.

In certain embodiments an inert gas may be used, such as argon or helium. In certain embodiments, nitrogen gas may be used, and may be considered inert for iron-based powders at temperatures less than 250 degrees centigrade.

In certain embodiments, the build material powder may be prohibited from contacting a specific gaseous atmosphere. In certain embodiments, a build material powder may be prevented from contacting oxygen or any oxygen containing gas. In certain embodiments a build material powder may be prevented from contacting water vapor or any water vapor containing gas. One skilled in the art will appreciate that different alloys will exhibit different sensitivities and reactivities toward identical atmospheres.

In certain embodiments, a gaseous atmosphere may be substantially prevented from contacting build material powder, such as by providing a vacuum.

In certain embodiments, any combination of process features may be included to cure the build material powder. In certain embodiments, a first set of process features may be utilized to cure a build material powder in an initial state (the initial state may be the state the powder is received in from a supplier (a “virgin” powder), in certain embodiments), and a second set of process features may be utilized to cure a build material powder in a following state (the following state may be the state of the powder after it has been used in a binder jet printing process, in certain embodiments).

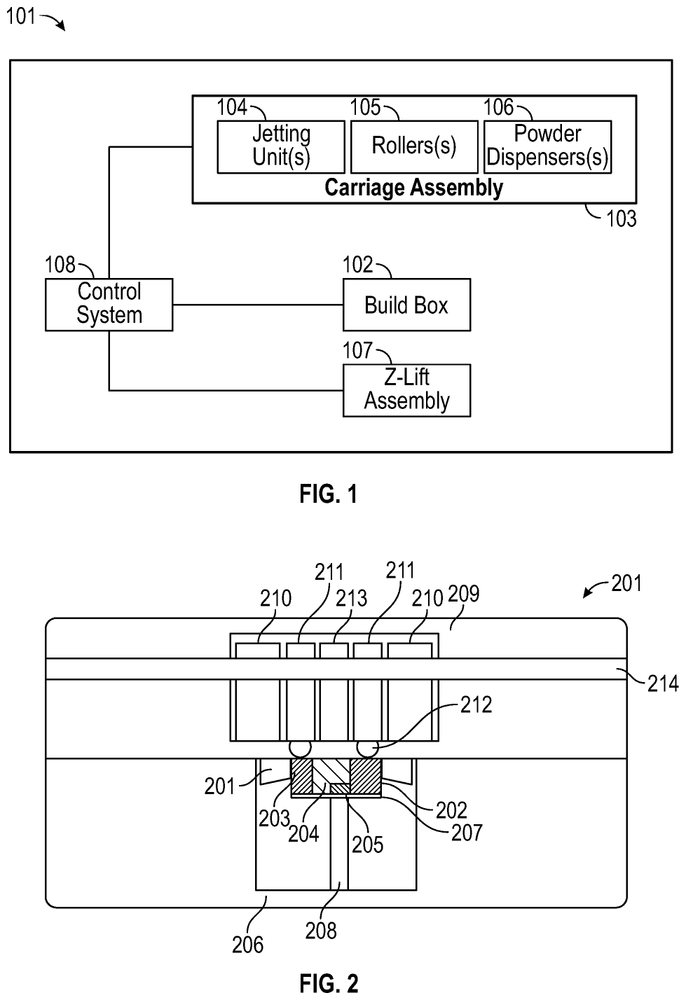

A binder jetting additive manufacturing system for which the present disclosure provides improvements includes a number of system components in a printer enclosure. With reference to FIG. 1, these include a build box 101 wherein articles are manufactured by the process of subsequent layers of powder that are bound in predetermined patterns of binder. A carriage assembly includes a jetting unit or units, a roller or rollers, and a powder dispenser or dispensers. The carriage assembly is moved relative to the build box during the printing process. In certain embodiments, the carriage assembly is traversed over the build box via an interface with a frame. The build box is moved vertically with respect to the carriage during the printing process so that each successive layer of powder may be spread and binder jetted.

With reference to FIG. 1, a binder jetting printer 101 includes a build box 102 where a part is to be manufactured. A carriage assembly 103 is moved relative to the build box 102 to deposit successive layers of build material powder and binder to form parts. In certain embodiments, the binder jetting printer 101 can be used to manufacture metal parts. In these instances, the build material powder is metal powder, and the part is later sintered to densify the part. The carriage assembly includes jetting unit(s) 104 for depositing binder, roller(s) 105 for spreading powder layers prior to binder jetting and powder dispenser(s) 106 which meter build material powder for successively printed layers. In alternate embodiments, build material powder may be metered from elevators and spread across the build box. In the embodiment of FIG. 1, the printer 101 includes a lift assembly 107 which moves a build platen within the build box down as successive layers are printed. A control system 108 controls the various elements of the binder jetting printer 101.

FIG. 2 depicts a side cutaway view of a binder jetting printer 201. A build box 202 contains loose powder 203 and a part 204 being manufactured and potentially support structures 205. A lift assembly 206 is configured to raise and lower the build box and build platen 207 to facilitate the printing process. A lift 208 raises and lowers a build platen 207. A print carriage 209 traverses relative to the build box. In the depicted embodiment, the carriage 209 moves while the build box 202 is maintained in a static position, though the build box 202 could alternatively move while the carriage 209 is maintained in a static position. In the depicted embodiment, the carriage 209 includes an arrangement of components for use in jetting. In the embodiment, printing is bi-directional, i.e., in a first direction-left to right with reference to the figure, and then from right to left. To facilitate bi-directional printing, the depicted carriage 209 includes powder dispensing units 210, powder roller units 211 having rollers 212 and a jetting unit 213. The powder dispensing units 210 and powder roller units 211 alternate depending on the printing direction so that powder is dispensed ahead of the roller which distributes the powder before the single jetting unit 213 deposits binder. Excess build material powder dispensed during the printing process is collected as overflow powder for subsequent reuse. Rail system 214 facilitates the movement of print carriage 209.

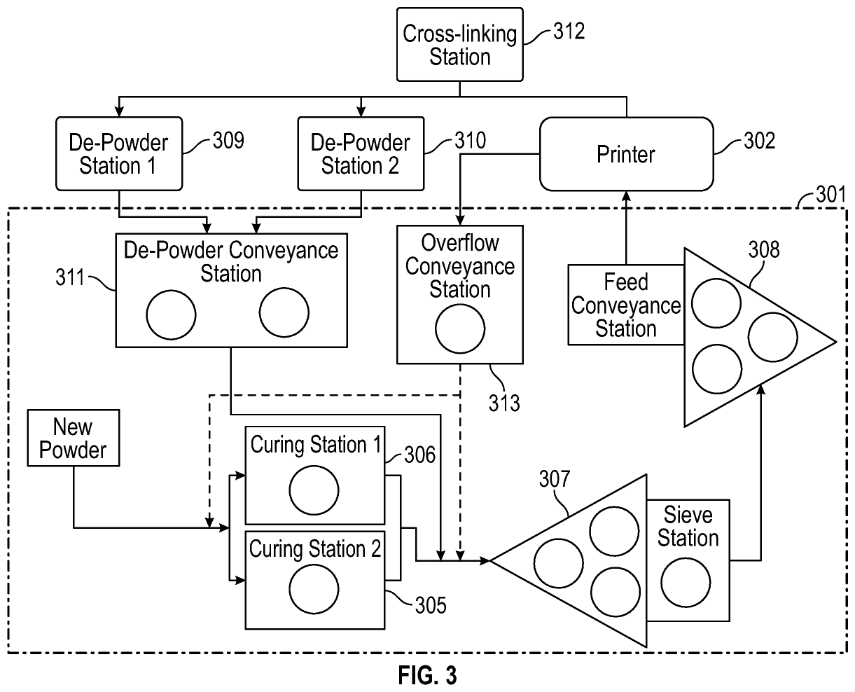

FIG. 3 depicts an embodiment complete binder jetting additive manufacturing setup containing a powder processing unit (PPU) 301. Solid line arrows represent flow of powder between elements of the PPU 301 and broken line arrows represent flows of powder that occurs selectively if certain conditions are met. Although a binder jetting printer 302 and first de-powdering station 309 and second de-powdering station 310 are part of the overall system they are excluded for the purposes of the present application as not a part of the powder processing unit. In the schematic of FIG. 3 each circular element represents a single drum of build material powder. It should be understood that the number of each element (ex. Curing station) of the system may be altered without departing from the present disclosure.

First curing station 305 and second curing station 306 are configured to split the workload of curing drums of build material powder that require curing. In some embodiments, build material powder that requires curing may include new powder. In some embodiments, build material powder that requires curing may include powder that has been recycled (recovered) from overflow at least once, or in an embodiment more than three times. The drums of cured build material powder are then transferred to a sieve station 307. Here, cured build material powder is passed through a sieve and filled into different drums. In certain embodiments, the use of a sieve may be desirable to remove clumps of powder, where the clumps may form in response to any force or mechanism tending to agglomerate or otherwise promote cohesion among the powder grains from which the build material powder is comprised. For example, agglomeration of the build material powder may result from one or any of: the exposure of the build material powder to humidity, or by the unintended deposition of binder in a region of the build material powder that was not intended to be bound, or by the presence of a disintegrated portion of a bound object from build material powder in a powder bed, among other mechanisms for example. In certain embodiments, the use of a sieve may be useful to separate large objects which are not intended to be included with the build material powder, such as: bound clumps of build material power, metal shavings, fibers, large dust particles, dirt, sand, hardware (such as nuts, bolts, screws, other fasteners, for example), or any other foreign object. In some embodiments, it may be desirable to load the sieve station with cured build material powder from different sources, to promote blending and homogenization of the different powders during the sieving step (ex. one drum of powder from the depowder station, one drum of uncured powder from the overflow station, and one drum of cured powder from the curing station). It should be realized that other combinations of drum sources may be utilized, including the use of only one source of powder (ex. three drums of cured new powder). The size of the sieve used may depend on the build material powder being used. A sieve opening size may be chosen to be somewhat larger than the largest expected particles in a given build material powder. For example, for a powder having a distribution of powder with a D90 of 25 μm (that is, 90% of the particles by mass are less than 25 μm), a sieve with opening size of 45 microns may be selected. Those drums are then passed to a feed conveyance station 308. In an embodiment, it may be desirable to load the printer supply station with cured build material powder from different sources, to promote blending and homogenization of the different powders during the conveyance step (ex. one drum of powder from the de-powder station, one drum of uncured powder from the overflow station, and one drum of cured powder from the curing station). It should be realized that other combinations of drum sources may be utilized, including the use of only one source of powder (ex. three drums of cured new powder). The feed conveyance station 308 feeds build material powder to the binder jetting printer 302 which additively manufactures parts. These parts are contained in build boxes that also contain loose powder surrounding the parts, which is a byproduct of the manufacturing process. These build boxes are transferred to a first de-powder station 309 and optionally a second de-powder station 310 where the parts are de-powdered. The build material powder recovered during the de-powdering is collected by de-powder conveyance station 311 into drums, which then may be transported to the sieve station 308 for reuse. Bound parts may also be cross-linked or otherwise thermally processed in a cross-linking station 312. During the printer process excess powder is collected from the printer 302 and transferred to an overflow conveyance station 313. Depending on the number of times that build material powder has recycled through printer 302, it may either be returned from the overflow conveyance station 313 directly to the sieve station 307 or, if it has been recycled too many times, may be sent to be cured by curing stations 305 and 306. For some build material powders, it has been observed that powder that has been recycled three times may be sieved and then recycled while once build material powder has been recycled four times it is beneficial to recure it. It should be understood that for some build material powders, overflow build material powder may be cured after a single use in the printer, or after any other predetermined number of uses in the printer. In certain embodiments, build material powders of the same material (such as 316 stainless steel, for example) may exhibit different recycling behavior (e.g., requiring curing after different amounts of recycling) depending upon the manufacturer and/or size distribution of the build material powder.

For concise understanding of the present disclosure, build material powder may be considered to exist in several different conditions. For the present disclosure, a first condition is defined as powder that requires curing before use, whether as new powder or powder requiring recycling, and has also not been sieved. A second condition powder is defined as powder that does not require curing, but that does require sieving before use. A third condition powder is defined as immediately ready for use in a binder jet printing. A fourth condition powder is defined as powder that has undergone less than a predetermined number of reuses and is suitable for use after sieving, but has not yet been sieved.

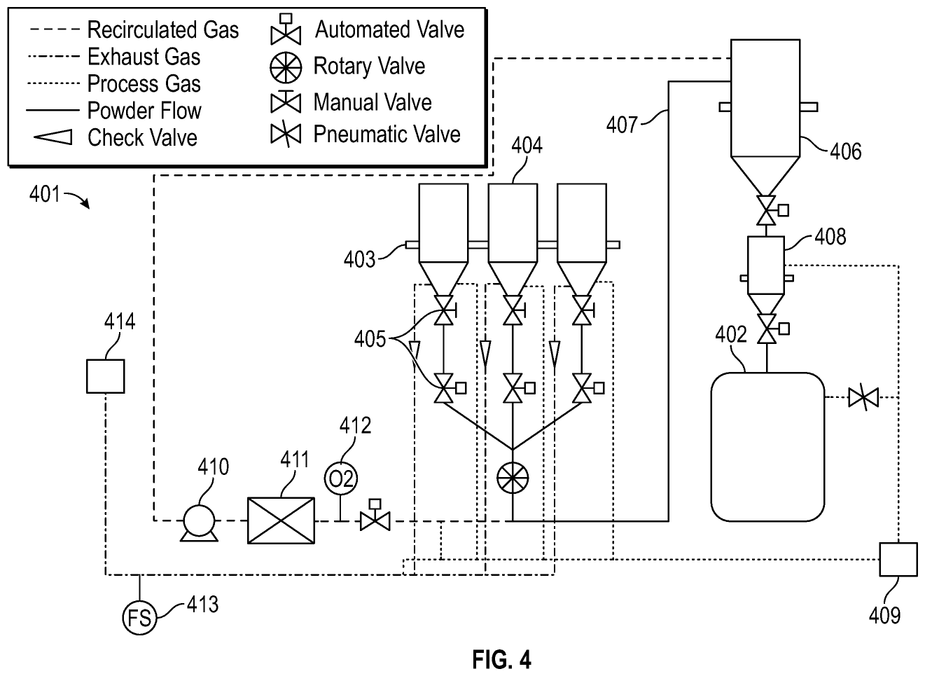

With reference now to FIG. 4, a feed conveyance system 401 is configured to feed build material powder to a binder jetting printer 402. A drum receiver structure 403 is configured to receive at least one drum of third condition build material powder, and in the embodiment three drums 404 of build material powder. A configuration of valves 405 can selectively dispense build material from one or more of the drums 404. For example, build material powder may only be flowed from one of the drums 404 or more than one, allowing mixing of the same or different build material powders. Powder is flowed from the drums 404 via a conveyance loop 407 to a separator 406 that separates the powder from the conveyance gas stream. From the separator 406 build material is passed through an intermediate holding vessel 408 to binder jetting printer 402. A process gas source 409, which may be for example a canister containing system, provides process gas flow into the system. The process gas may be an inert gas such as argon or nitrogen. By providing process gas flow to the conveyance loop it may be inerted, for example to an oxygen level lower than a Limiting Oxygen Concentration (LOC) below which powder combustion cannot occur. In certain embodiments, the use of an inert gas may be required to prevent a change in or damage to a build material powder. For example, an inert gas substantially free of oxygen and water vapor, such as argon or nitrogen, may be required when commercially pure copper or other similar copper-containing alloys comprise the build material powder, for at least the reason that the copper may become oxidized and the properties of the powder therefore affected during processing. Process gas may also be provided to the drums 404. Process gas may also be recirculated from the separator 406 back into the conveyance loop 407 via a blower 410 and optionally through a heat exchanger 411 to cool the gas. An oxygen measuring device 412 monitors the oxygen content of recirculated process gas. When initially inerting the conveyance loop, a higher flow of process gas may be applied until a maximum allowable oxygen threshold is not exceeded. The operation of blower motors and other system elements which may provide an ignition energy to build material powder may be interlocked to a measured oxygen level, to prevent their activation until the oxygen threshold is achieved. A flow switch 413 monitors flow of exhaust gas to a facility exhaust 414.

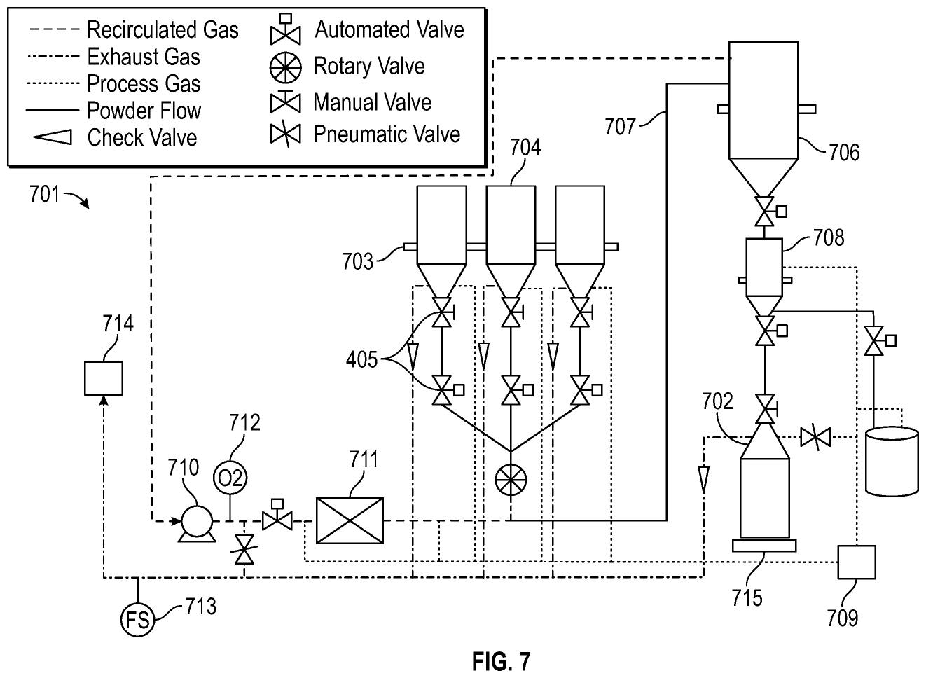

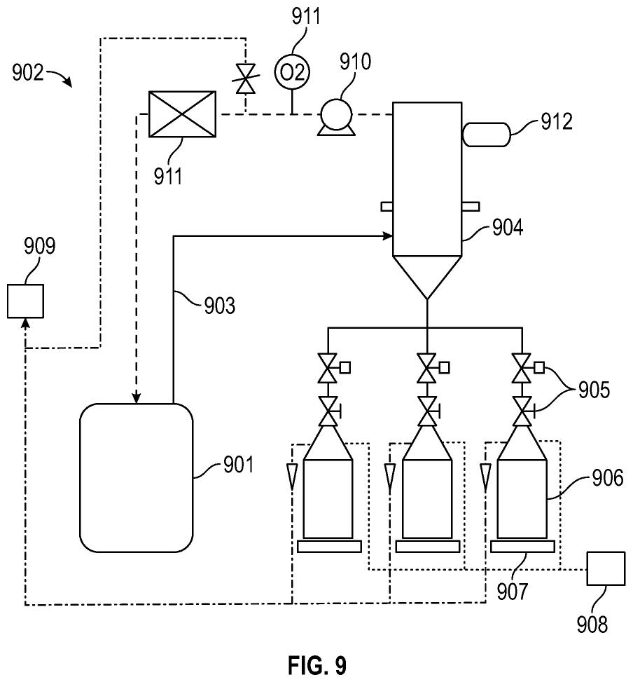

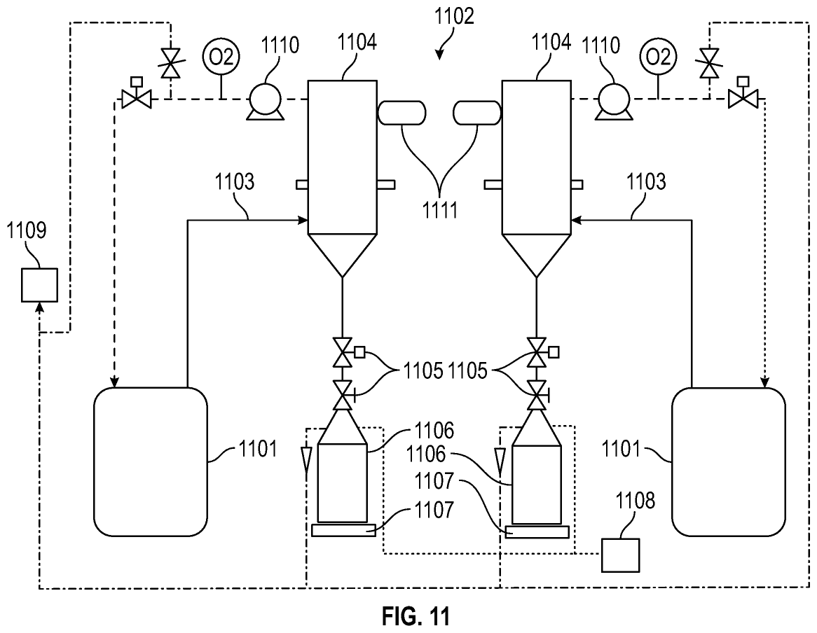

Disclosed is an embodiment configuration of valves controlling gaseous connection of the components of the feed conveyance system 401, however it should be understood that the configuration of valves and their type may be altered without departing from the disclosure. This similarly applies to the other powder processing unit stations identified in the present disclosure. The legend on FIGS. 4 and 7 also applies to FIGS. 9 and 11.

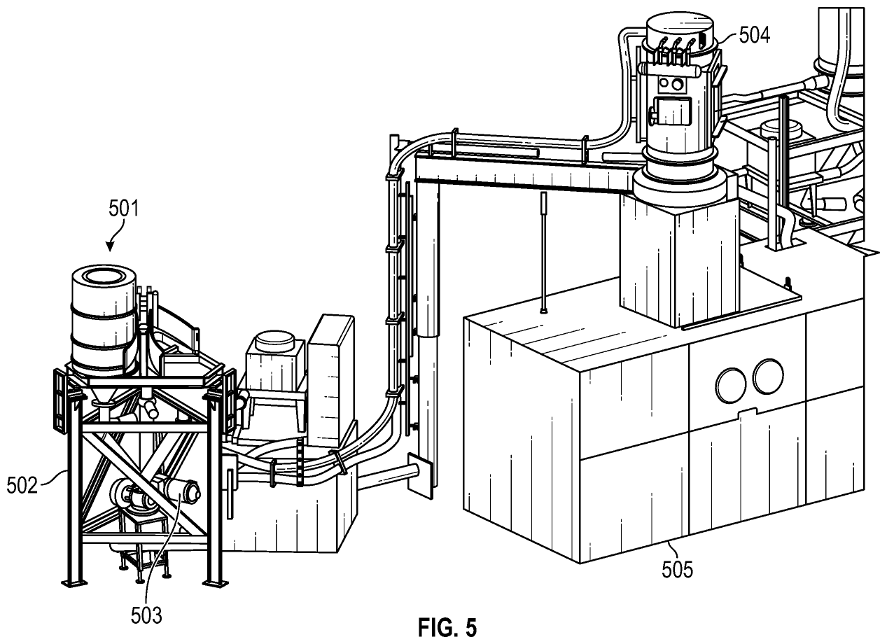

FIG. 5 depicts an embodiment conveyance system in which a single drum 501 is loaded into a drum receiver structure 502, wherein a blower 503 is configured to cause build material powder to flow to a separator 504 before passing to a binder jetting printer 505.

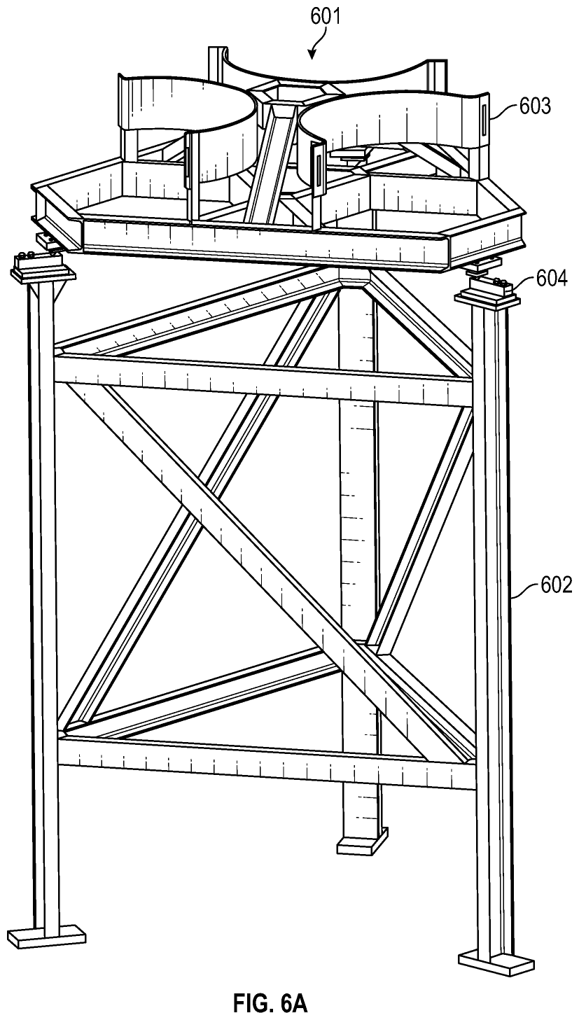

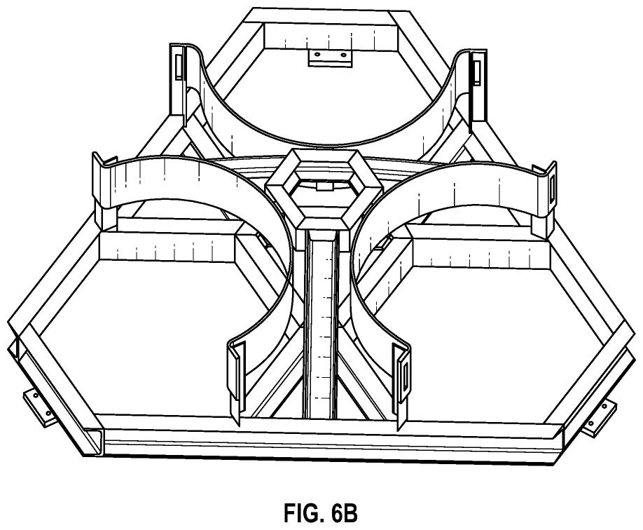

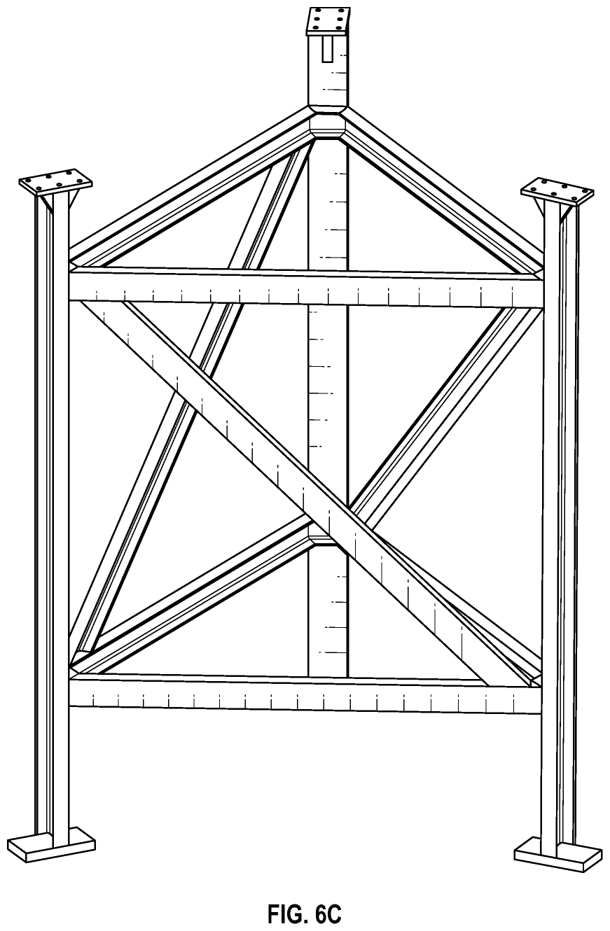

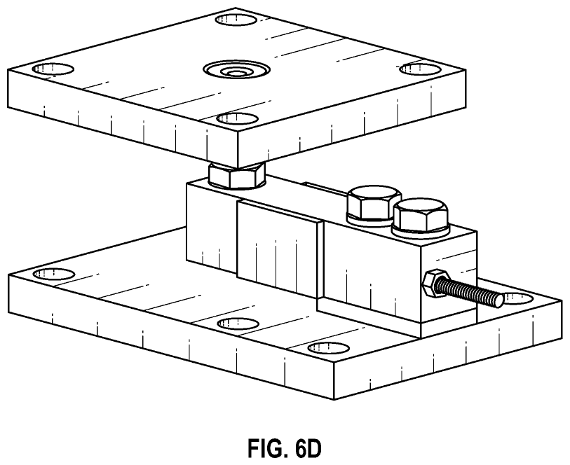

FIG. 6A depicts an embodiment support structure 601 having a support frame 602 providing a base for a drum holding unit 603 which is connected via a plurality of weight sensing connectors 604 which together are configured to determine an amount of build material powder in drums loaded into the drum holding unit 603. FIG. 6B is a perspective view of the drum holding unit 603. FIG. 6C. is a perspective view of the support frame 602. FIG. 6D is a perspective view of the weight sensing connectors 604.

With reference now to FIG. 7, a sieve system 701 is configured to deliver sieved build material powder to a sieved drum 702. A drum receiver structure 703 is configured to receive at least one un-sieved drum of second condition or fourth condition build material powder, and in the embodiment three drums 704 of build material powder. A configuration of valves 705 can selectively dispense build material from one or more of the drums 704. For example, build material powder may only be flowed from one of the drums 704 or more than one. Build material powder is flowed from the drums 704 via a conveyance loop 707 to a separator 706 that separates the powder from the conveyance gas stream. From the separator 706 build material is passed through sieve 708 to sieved drum 702 as third condition build material powder. A process gas source 709, which may be for example a canister containing system, provides process gas flow into the system. The process gas may be an inert gas such as argon or nitrogen. By providing process gas flow to the conveyance loop 707 it may be inerted. Process gas may also be provided to the drums 704. Process gas may also be recirculated from the separator 706 back into the conveyance loop 707 via a blower 710 and optionally through a heat exchanger 711 to cool the gas. An oxygen measuring device 712 monitors the oxygen content of recirculated process gas. When initially inerting the conveyance loop, a higher flow of process gas may be applied until a maximum allowable oxygen threshold is not exceeded. A flow switch 713 monitors flow of exhaust gas to a facility exhaust 714. A weighing plate 715 measures the weight of drum 702 to determine when it is full of sieved build material powder.

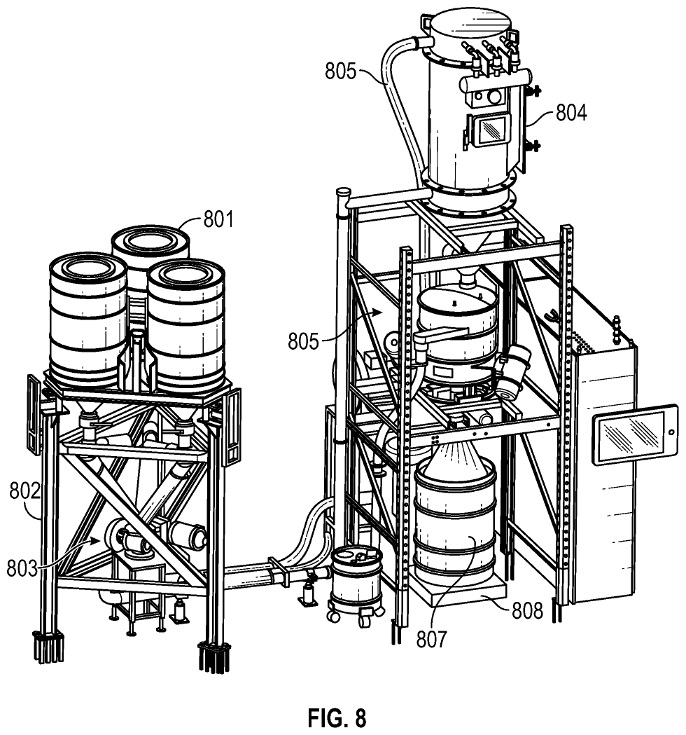

FIG. 8 depicts an embodiment sieve station in which a drums 801 are loaded into a drum receiver structure 802, wherein a blower 803 is configured to cause build material powder to flow to a separator 804 through a conveyance loop 805 before passing through a separator 806 then a sieve 807 into a waiting drum 808 sitting on a weighing plate.

Now with reference to FIG. 9, excess build material powder is passed from a binder jetting printer 901 to an overflow station 902 via a conveyance loop 903 of the overflow station 902. The excess build material is received to a filter separator 904. A configuration of valves 905 selectively permits build material powder from the filter separator 904 to fill one or more of containers 906. Each of containers 906 is positioned on a weighing plate 907 to determine the level of build material powder in each of containers 906 so that filled containers may be removed for further processing. A process gas source 908 provides a process gas to containers 906 which may be an inert gas such as argon or nitrogen. Exhaust gas is outflowed from the system through facility exhaust 909. The flow of powder from printer 902 is accompanied by a flow of process gas that facilitates movement of the build material powder. Process gas is recirculated by a blower 910 through a heat exchanger 911 to cool the gas. When initially inerting the drums 907, a higher flow of process gas may be applied until a maximum allowable oxygen threshold is not exceeded. A pressure accumulation tank 912 may be disposed to periodically supply a positive pressure flow of process gas to the filter inside the separator, to clear powder accumulated on the filter and thereby maintain high flow and separator efficiency.

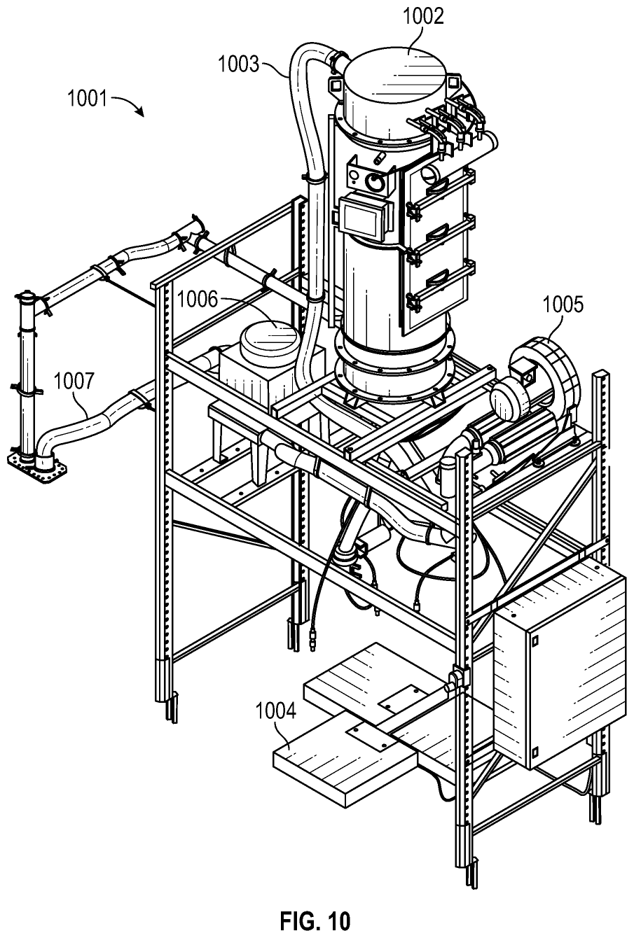

FIG. 10 depicts a perspective view of an embodiment overflow processing station 1001 wherein build material powder is provided to a filter separator 1002 through a conveyance loop 1003. It should be noted that while the separators in the various figures are shown as filter separators, it should be understood that other types of separators (ex. cyclonic separators) may be used without substantially altering the functionality of the PPU. Weighing plates 1004 are in FIG. 10 ready to receive empty containers for filing during printing operations. Blower 1005 is configured to recirculate process gas back to a binder jetting printer (not-pictured) through a heat exchanger 1006 and return conveyance loop 1007.

Now with reference to FIG. 11, excess build material powder is passed from de-powder units 1101 to de-powder station 1102 (components other than the de-powder stations) via conveyance loops 1103 of the de-powder station 1102. The de-powdered build material is received to filter separators 1104. A configuration of valves 1105 selectively permits build material powder from the filter separators 1104 to fill one or more of containers 1106. Each of containers 1106 is positioned on a weighing plate 1107 to determine the level of build material powder in each of containers 1106 so that filled containers may be removed for further processing. A process gas source 1108 provides a process gas to containers 1106 which may be an inert gas such as argon. Exhaust gas is outflowed from the system through facility exhaust 1109. The flow of powder from de-powder 1101 is accompanied by a flow of process gas that facilitates movement of the build material powder. Process gas is recirculated by blowers 1110. When initially inerting the drums 1106, a higher flow of process gas may be applied until a maximum allowable oxygen threshold is not exceeded. Pressure accumulation tanks 1111 may be disposed to periodically supply a positive pressure flow of process gas to the filter inside the separator, to clear powder accumulated on the filter and thereby maintain high flow and separator efficiency.

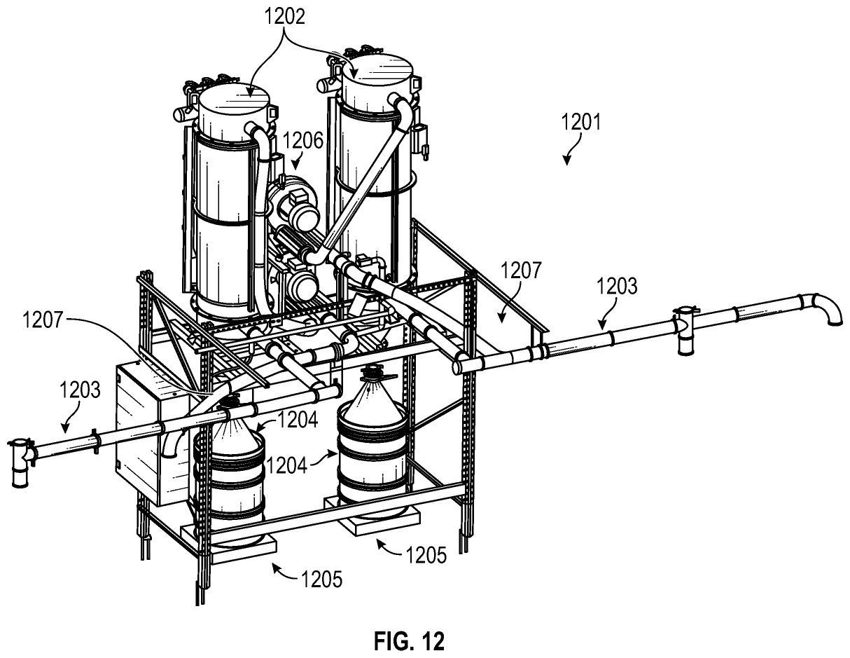

FIG. 12 depicts a perspective view of an embodiment de-powder station 1201 wherein build material powder is provided to a filter separators 1202 through conveyance loops 1203. Containers 1204 rest on weighing plates 1205. Blowers 1206 are configured to recirculate process gas back to de-depowder units (not-pictured) through conveyance loops 1207.

The containers for use with the above defined PPU components may include unique identifiers. These identifiers may be used with a management system to track the containers and information about the build material powder contained, including amount of powder, type of powder, condition of powder, and information related to the processing history of the powder contained. This provides the ability to ensure that the correct build material powder for each operation is employed and the overall amount of build material powder consumed is trackable.

The unique identifiers may include a laser etched identification marker such as a dot pattern, barcode, QR-code, or other machine readable identifier. The machine readable identifier may be augmented by a similarly etched number for reading by humans. A dot peened pattern, physically scribed pattern, chemically etched pattern, or similar may also be used. These identifiers are advantageous because they are resistant to high temperatures (which is endured during at least the curing process). Placement in an area of the drum that is not subject to significant wear (such as one of the ends) is also desirable.

In some embodiments the drum contains a cone (or similar) shaped end. Such an end can be expected to be cooler than the central portion of the drum, and therefore certain identifiers (e.g., ink, plastic, etc. . . . ) may be employed there that are more sensitive to temperature but are still insensitive to the temperature in cooler portions of the drum.

There may be some embodiments where a low temperature (e.g., below 150° C.) is required for the build material powder curing step, in which case a laser etched (or similar) marking may not be required, without specific regard to placement in hot or cold regions of the drum.

In some embodiments, powder conveyance loops may be configured to convey build material powder in any of several different flow regimes, as will be understood by one of ordinary skill in the art. In some embodiments, a dense phase flow regime (for example, plug flow) may be desirable. Dense phase conveyance is typically characterized by relatively high differential pressures, with lower flow rate (and therefore lower gas and powder velocities). In a dense phase flow, build material powder may be conveyed in discrete slugs (herein also referred to as or plugs, clumps or packets), separated from one another by gas. One benefit of dense phase conveyance is that it may reduce the velocity of powder particles in the powder conveyance loop, thereby reducing abrasion or wear on tubes, elbows, collectors, and other conveyance components. Additionally, plug flow or dense phase conveyance may result in lower likelihood of causing particle segregation (e.g. removal or separation of fines) in collection vessels such as filter separators or cyclonic collectors. The dense phase flow may be best suited for conveyance of powder from drums, storage vessels, collection vessels, and the like.

In other embodiments, a dilute phase flow regime may be desirable for powder conveyance. In a dilute phase conveyance, build material powder may be conveyed continuously, and is dispersed or mixed with a carrier gas at a lower density relative to a plug flow. Dilute phase conveyance is typically characterized by higher flow rates and lower pressures. This regime of powder conveyance may be better suited for collection and transportation of powder in areas where it may be dispersed or in dust form, including collection of dust and suspended powder that may be created for example during the powder spreading or depowdering processes.

What is claimed is:

1. A method of processing build material powder for binder jetting additive manufacturing, comprising:
receiving at a sieving station a first container of second condition powder;
passing the second condition powder to a sieving unit of the sieving station via a first conveyance loop;
processing the second condition powder through the sieving unit and into a second container as third condition powder;
transporting the second container of third condition powder to a feed conveyance unit; and
passing the third condition powder to a feed unit of a binder jetting printer via a second conveyance loop.

2. The method of claim 1 wherein at least one of the first conveyance loop and the second conveyance loops is inerted.

3. The method of claim 1 wherein feed conveyance station is configured to receive a plurality of containers.

4. The method of claim 1 further comprising:
prior to the receiving at the sieve station the first container of second condition powder, providing the first container containing a first condition powder to a curing station; and
curing the first condition powder to second condition powder.

5. The method of claim 1 wherein the feed conveyance unit is configured to receive three containers of build material powder, each in a dispensing orientation.

6. The method of claim 5 wherein the feed conveyance unit is configured to feed build material powder from two or more of the three containers simultaneously.

7. The method of claim 5 wherein the feed conveyance unit includes at least one weight sensor associated with each of the three containers.

8. The method of claim 7 wherein the feed conveyance unit is configured to determine from sensor data from the weight sensors a level of build material powder in each of the three containers.

9. The method of claim 4 wherein at least a portion of the first condition powder is received from an overflow conveyance unit.

10. The method of claim 1 wherein at least a portion of the second condition powder is received from a de-powdering station.

11. A system for processing build material powder for binder jetting additive manufacturing, comprising:
a curing station configured to receive and process a first container of first condition powder to convert the first condition powder to a second condition;
a sieve station configured to receive the first container of build material powder from the curing station and sieve the build material powder from the second condition to a third condition and into a second container; and
a feed conveyance station configured to receive the second container and convey the third condition powder to a feed unit of a binder jetting printer through a second inert conveyance loop.

12. The system of claim 11 wherein at least one of the first conveyance loop and second conveyance loop is inerted.

13. The system of claim 11 further comprising an overflow conveyance station configured to receive an amount of fourth condition powder from the binder jetting printer through a third inert conveyance loop and into a third container.

14. The system of claim 11 wherein the feed conveyance station is configured to receive three containers in a triangular configuration.

15. The system of claim 12 wherein the feed conveyance station is configured to mix powder from two or more of the three containers.

16. The system of claim 13 wherein the sieve station is configured to mix powder from two or more of three containers.

17. The system of claim 13 wherein the first container, second container and third container each have a receive orientation and a dispense orientation.

18-20. (canceled)
